(19) United States
(12) Patent Application Publication
(10) Pub. No.: US 2022/0231586 A1
(43) Pub. Date: Jul. 21, 2022

(54) HIGH-EFFICIENCY DIRECT CURRENT MOTOR

(71) Applicant: Joowon HWANG, Hwacheon-gun (KR)

(72) Inventor: Joowon HWANG, Hwacheon-gun (KR)

(21) Appl. No.: 17/595,763

(22) PCT Filed: Sep. 23, 2020
(86) PCT No.: PCT/KR2020/012808

§ 371 Date: Nov. 23, 2021

(30) Foreign Application Priority Data
Oct. 19, 2019 (KR) 10-2019-0130303

(51) Int. Cl. H02K 16/02; H02K 1/2798; H02K 1/18; H02K 21/24

(52) U.S. Cl. CPC H02K 16/02; H02K 21/24; H02K 1/182; H02K 1/2798

(57) ABSTRACT

The present invention relates to a DC motor that is used in overall industrial fields producing electric cars, cordless vacuum cleaners, drones, and the like, and the existing high-efficiency DC motor, in which top and bottom permanent magnets have different polarities are arranged in a state where their centers alignedly face each other and electromagnets are disposed between the top and bottom permanent magnets to utilize magnetic forces to the maximum and to produce a rotation force thereof, is suggested. However, the existing high-efficiency DC motor has the following problems. Firstly, the rotation direction is not constant according to the initial position of the rotor, and secondly, the top and bottom permanent magnets attract the magnetic materials of the electromagnets to inhibit the rotation, and to solve such problems, accordingly, a high-efficiency DC motor according to the present invention is configured to allow centers of bottom permanent magnets to be facingly disposed between top permanent magnets, thereby exhibiting excellent rotation force and torque when compared to a general BLDC motor.

### TECHNICAL FIELD

The present invention relates to a direct current (DC) motor that is capable of being used in overall industrial fields producing automobiles, drones, electronic products, industrial equipment, and the like, and more specifically, to a DC motor that is capable of being configured to arrange permanent magnets on top and bottom thereof and to place electromagnets between the top and bottom permanent magnets to allow the electromagnetic fields generated from the electromagnets to be transferred to the top and bottom permanent magnets simultaneously to rotate the top and bottom permanent magnets, thereby making use of the electromagnetic fields generated from the electromagnets to the maximum and reducing a weight thereof to achieve a high efficiency thereof.

### BACKGROUND ART

A DC motor, which is used in overall industrial fields, is largely classified into a brushed DC motor and a brushless DC (BLDC) motor. The BLDC motor operates, while not using a plurality of electromagnets disposed therein simultaneously, but sequentially applying electricity to some of electromagnets to generate magnetic forces so that permanent magnets rotate according to the movements of the magnetic forces of the electromagnets. In this case, N and S poles are generated from the electromagnets, but in really rotating a rotor, only one polarity is needed, so that the other polarity energy produced by the electricity is lost. However, the magnetic forces flow to another electromagnet through an iron core, and even in this case, energy loss still occurs. In a process of making the BLDC motor, further, it is hard to automatically wind coils onto iron cores, and even though the winding is automatically carried out, the time for making the BLDC motor is long to thus cause the manufacturing cost of the motor to be undesirably raised. Besides, a high-priced motor driving controller is additionally needed to thus increase the overall manufacturing cost. A basic arrangement method of the DC motor, in which the permanent magnets are arranged on top and bottom of the motor and electromagnets are arranged between top and bottom permanent magnets, as suggested in the present invention, has been already introduced in conventional technologies. However, the conventional technologies have the top and bottom permanent magnets having different polarities and facing aligned on their centers in common. In this case, two problems may occur. Firstly, the position of the rotor at a stopped state is not constant according to situations, so that initial rotation is not carried out or a rotation direction varies, and secondly, as a rotation speed of the rotor becomes fast, power polarity variation time during which power polarities are alternately inputted to the electromagnets and magnetic field variation time may become fast, so that polarity variations are delayed by the remaining current of the magnetic fields generated from the electromagnets on the coils or iron cores to cause the permanent magnets to apply their force to directions inhibiting the rotation of the rotor, thereby undesirably having a lower rotation speed than the existing BLDC motor.

### DISCLOSURE

### Technical Problem

As mentioned above, the high-efficiency DC motor as suggested in the conventional technology is configured to allow the plurality of electromagnets to be arranged to a circular shape to generate one polarity from tops thereof and the other polarity from bottoms thereof with respect to ground and to allow the plurality of permanent magnets to be disposed on top and undersides of the electromagnets, while facing each other to have their centers aligned with each other, thereby utilizing the magnetic forces of the electromagnets to the maximum to rotate the motor. After the motor is manufactured using the above-mentioned technology and tested, however, it is found that the motor does not rotate or the rotation direction of the motor may be varied according to the initial position of the rotor, and to solve such a problem, accordingly, another technology and additional devices are needed. So as to rotate the rotor, further, the current polarities of the electromagnets are varied according to the positions of the permanent magnets to thus vary the polarities of the magnetic fields produced from the electromagnets, and in this case, at the moment when the polarities are varied, unfortunately, the top and bottom permanent magnets attract the magnetic materials of the electromagnets to thus inhibit the rotation of the rotor, so that as the second problem, the rotation speed of the conventional high-efficiency DC motor is slower than that in the existing BLDC motor. The conventional technology related to the high-efficiency DC motor has been suggested since 1990 and technologies similar thereto have been proposed even up to now. Due to the above-mentioned problems, however, the conventional high-efficiency DC motor is not commercialized well, thereby failing to replace the BLDC motor. Accordingly, the present invention has been made to solve the above-mentioned two problems occurring in the conventional high-efficiency DC motor in which the permanent magnets are arranged on top and bottom thereof and the electromagnets are disposed between the top and bottom permanent magnets, thereby ensuring high-speed rotation and high torque when compared to the existing DC motor.

### Technical Solution

To accomplish the above-mentioned objects, according to the present invention, unlike the existing motor as suggested in the conventional technology where the top and bottom permanent magnets have different polarities in a state where their centers alignedly face each other and the electromagnets are disposed between the top and bottom permanent magnets, there is provided a high-efficiency DC motor including top permanent magnets arranged to a circular shape around top of a rotation shaft in a vertical direction of the rotation shaft to allow the neighboring top permanent magnets to have different polarities from each other, bottom permanent magnets arranged to a circular shape around bottom of the rotation shaft in the vertical direction of the rotation shaft to allow the neighboring bottom permanent magnets to have different polarities from each other in a state where centers thereof are placed between the top permanent magnets, a plurality of electromagnets arranged to a shape of a cylinder between the top permanent magnets and the bottom permanent magnets to allow the neighboring electromagnets to have different polarities in the same direction as each other when electricity is applied thereto, the number of electromagnets being the same as the number of top permanent magnets and bottom permanent magnets, and a bottom metal plate disposed between the top permanent magnets and the bottom permanent magnets to fix the electromagnets thereto by means of fixing pins, wherein a rotor having the top and bottom permanent magnets rotates using attraction and repulsion between the top and bottom permanent magnets whose centers are misaligned and the electromagnets.

### Advantageous Effects

According to the present invention, the high-efficiency DC motor may replace the existing DC motor therewith because it provides a high efficiency, a low cost, and a high torque when compared to the currently commercialized DC motor, thereby exhibiting energy saving and reduction in a user's motor operating cost. Further, the high-efficiency DC motor according to the present invention is applied to wireless electrical equipment such as electric cars, flying cars, drones, and the like, and accordingly, the performance of the equipment can be greatly improved.

### DESCRIPTION OF DRAWINGS

FIG. 1 is a perspective view showing a high-efficiency DC motor according to the present invention.

FIG. 2 is an exploded perspective view showing the high-efficiency DC motor according to the present invention.

FIG. 3 is a sectional view showing an electromagnet-coupling plate of the high-efficiency DC motor according to the present invention.

FIG. 4 is a sectional view showing a bottom permanent magnet-coupling plate of the high-efficiency DC motor according to the present invention.

FIG. 5 is an enlarged view showing one electromagnet of the high-efficiency DC motor according to the present invention.

FIG. 6 is a first schematic diagram showing an operating principle of the high-efficiency DC motor according to the present invention.

FIG. 7 is a second schematic diagram showing the operating principle of the high-efficiency DC motor according to the present invention.

### EXPLANATIONS OF REFERENCE NUMERALS

10: High-efficiency DC motor
20: Electromagnet
100: Top rotation body on which permanent magnets are coupledly arranged
110: Screw hole for fitting a motor shaft
120: Top rotation plate
130: Support for fixing a bottom rotation body and circulating air in an interior of the motor
140: Permanent magnet
150: Rotation shaft for fixing top and bottom rotation plates coupled to each other to a bearing
200: Stator on which electromagnets are coupledly arranged
210: Fixing pin for fixing coils (230) to a metal plate
220: Coil winding bobbin
230: Coil
240: Metal plate for fixing electromagnets and serving as a heat releasing plate
250: Hole for passing rotation shaft therethrough to fix the rotation shaft to a bearing (460)
300: Bottom rotation body on which permanent magnets are coupled arranged
310: Bottom rotation plate
320: Hole for passing support (450) therethrough to fix the support to the metal plate (240)
400: Motor bottom support body for supporting the stator and the rotation bodies and having hall sensors
410: Motor bottom support plate
420: Hall sensor for sensing a magnetic field
430: 5 V wire for sensing rotor position from the two hall sensors and for operating a circuit
440: Wire for applying a voltage to the electromagnets
450: Support for fixing the metal plate for fixing the electromagnets to the motor bottom support plate
460: Bearing for fixing the rotation shaft of the rotation bodies and helping the rotation of the rotation bodies

### BEST MODE FOR INVENTION

To accomplish the above-mentioned objects, a high-efficiency DC motor according to the present invention includes top permanent magnets arranged to a circular shape around top of a rotation shaft in a vertical direction of the rotation shaft to allow the neighboring top permanent magnets to have different polarities from each other, bottom permanent magnets arranged to a circular shape around bottom of the rotation shaft in the vertical direction of the rotation shaft to allow the neighboring bottom permanent magnets to have different polarities from each other in a state where centers thereof are placed between the top permanent magnets, a plurality of electromagnets arranged to a shape of a cylinder between the top permanent magnets and the bottom permanent magnets to allow the neighboring electromagnets to have different polarities in the same direction as each other when electricity is applied thereto, the number of electromagnets being the same as the number of top permanent magnets and bottom permanent magnets, and a bottom metal plate disposed between the top permanent magnets and the bottom permanent magnets to fix the electromagnets thereto by means of fixing pins, wherein a rotor having the top and bottom permanent magnets rotates using attraction and repulsion between the top and bottom permanent magnets whose centers are misaligned and the electromagnets.

### MODE FOR INVENTION

Hereinafter, the present invention will be described in detail with reference to the attached drawings.

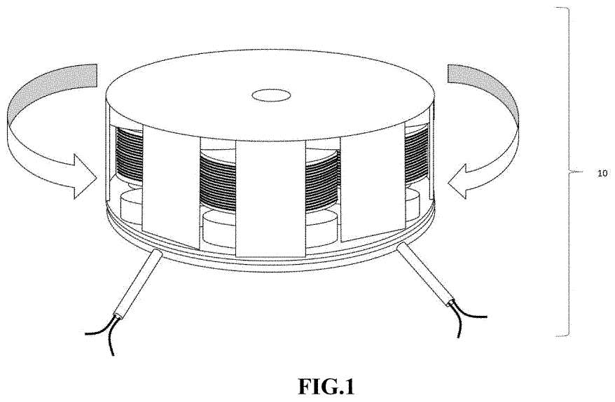

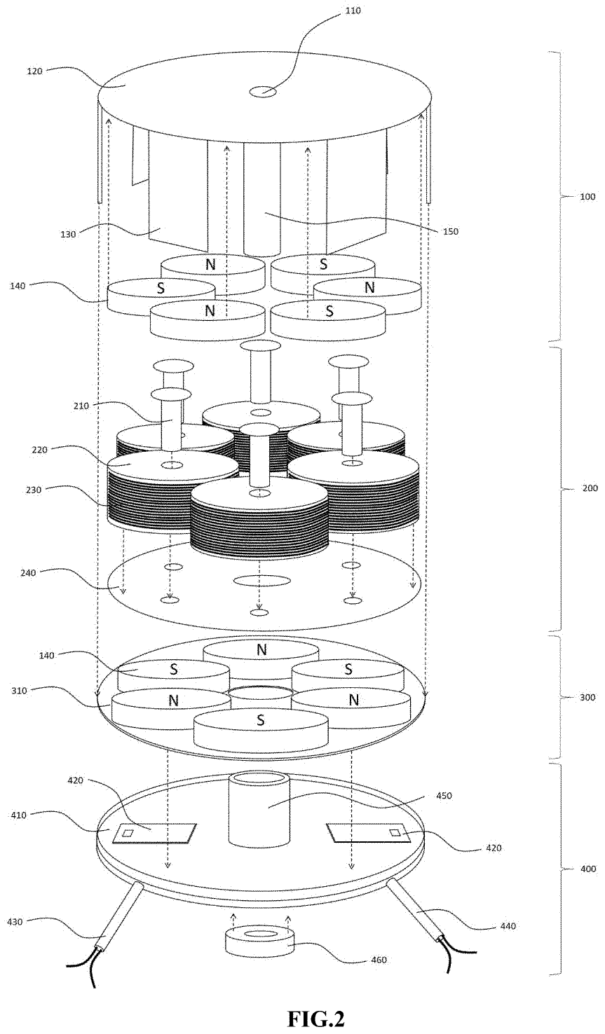

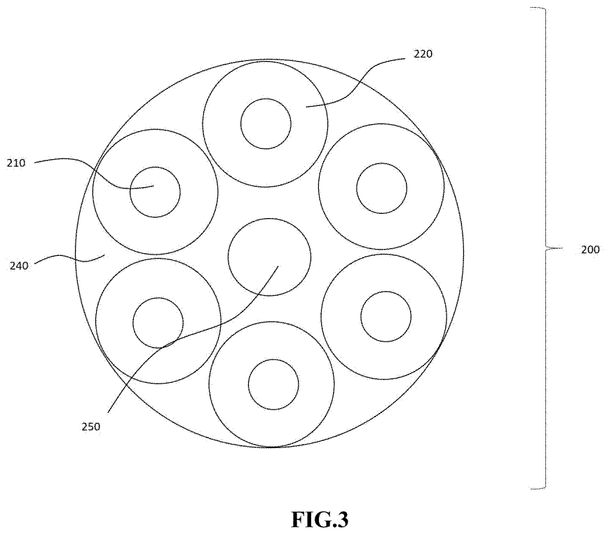

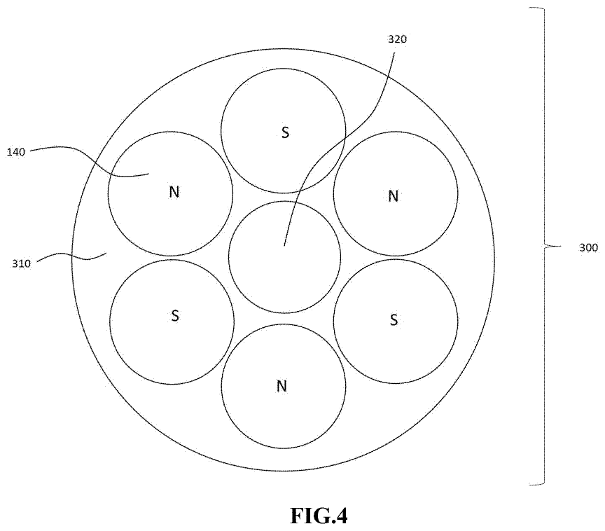

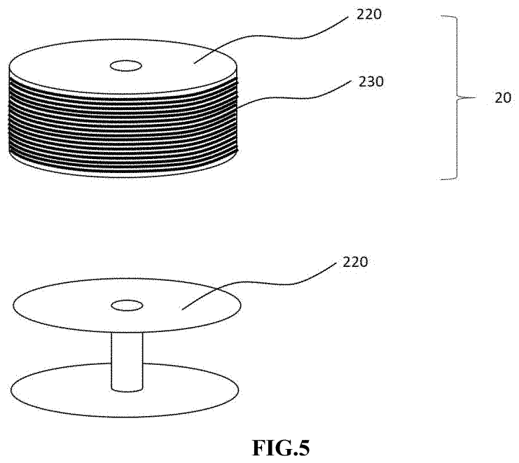

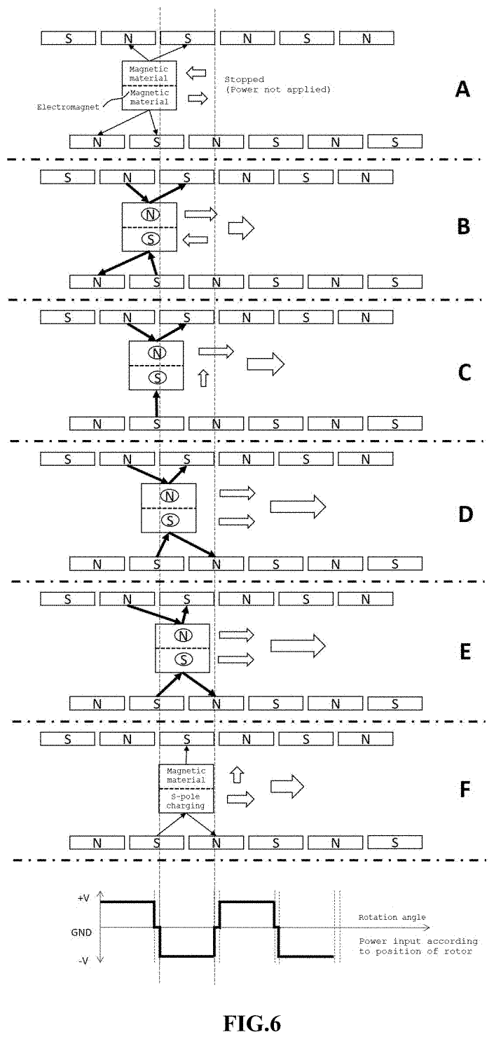

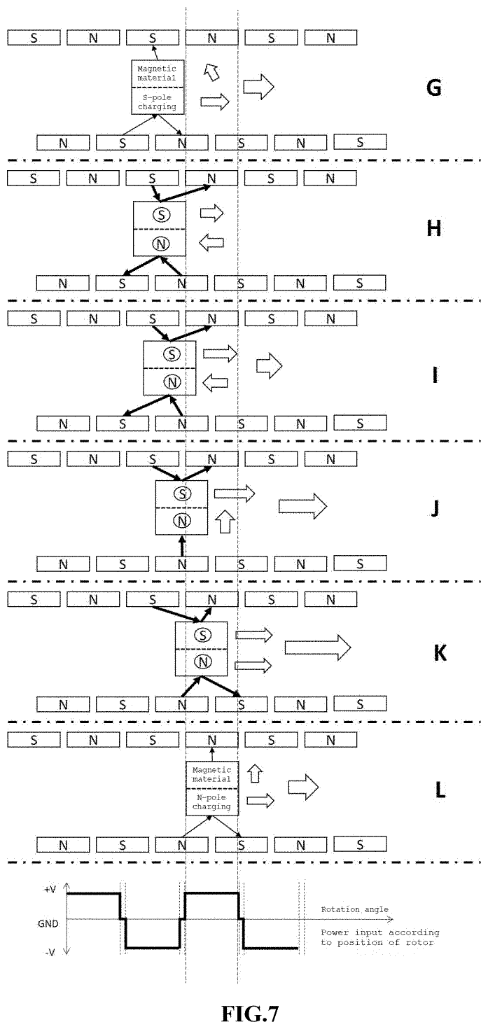

FIG. 1 is a perspective view showing a high-efficiency DC motor according to the present invention, FIG. 2 is an exploded perspective view showing the high-efficiency DC motor according to the present invention, FIG. 3 is a sectional view showing an electromagnet-coupling plate of the high-efficiency DC motor according to the present invention, FIG. 4 is a sectional view showing a bottom permanent magnet-coupling plate of the high-efficiency DC motor according to the present invention, FIG. 5 is an enlarged view showing one electromagnet of the high-efficiency DC motor according to the present invention, FIG. 6 is a first schematic diagram showing an operating principle of the high-efficiency DC motor according to the present invention, and FIG. 7 is a second schematic diagram showing the operating principle of the high-efficiency DC motor according to the present invention.

FIG. 1 shows a state where components of a DC motor 10 as shown in FIG. 2 are completely coupled to one another. A rotation direction of the DC motor 10 is determined according to arrangements of permanent magnets when the DC motor 10 is initially made. If it is desired to change the rotation direction of the DC motor 10 to the opposite direction thereto, a top rotation plate 120 is turned by 180° and coupled to a bottom rotation plate 310.

FIG. 2 is an exploded perspective view showing the DC motor 10 according to the present invention, and as shown, the top rotation plate 120 has a plurality of permanent magnets 140 arranged to a circular shape thereon to allow the neighboring permanent magnets 140 to have different polarities from each other. The top rotation plate 120 has a screw hole 110 formed thereon to couple a motor shaft thereto, and accordingly, the motor shaft made to a shape appropriate for power transmission is coupled to the screw hole 110. A plurality of supports 130 are arranged to a circular shape along the top rotation plate 120, vertically stand slantly with respect to a center axis of the motor to thus circulate heat generated from the interior of the motor, and couples the top rotation plate 120 to the bottom rotation plate 310. A stator 200 onto which electromagnets 20 are coupledly arranged is configured to allow the same number of electromagnets 20 as the number of permanent magnets 140 located on one side thereof to be arranged to a circular shape thereon. In this case, the electromagnets 20 are arranged to generate different polarities from the neighboring permanent magnets 140 when an electric current is applied to the electromagnets 20 simultaneously. To fix the electromagnets 20 to bobbins 220, fixing pins 210 made of a magnetic metal pass through the bobbins 220 and are coupled to a metal plate 240. In addition to fixing the electromagnets 20, the bobbins 220 serve as iron cores for increasing magnetic forces. The bottom rotation plate 310 has the same number of permanent magnets 140 as the number of permanent magnets 140 arranged on the top rotation plate 120 in the same arrangements as in the top rotation plate 120, and when the bottom rotation plate 310 is coupled to the top rotation plate 120 and the supports 130, the centers of the permanent magnets 140 of the bottom rotation plate 310 are misaligned to those of the top rotation plate 120 and thus placed on the central portion between the two permanent magnets located on the opposite side thereto when the permanent magnets 140 of the bottom rotation plate 310 face the permanent magnets 140 of the top rotation plate 120. A motor bottom support body 400 has two or more hall sensors 410 disposed on a support plate 410 to detect the positions of the permanent magnets 140. Using the position information of the permanent magnets 140 detected through the hall sensors 410, the power of polarities needed for the electromagnets 20 can be applied at an appropriate moment. The number of hall sensors 420 is at least two or more because of a rotation section where power is not applied to the electromagnets 20. The motor bottom support body 400 has a support 450 for fixing the metal plate 240 to which the electromagnets 20 are fixed thereto. Further, a bearing 460 is coupled to the support 450 to fix the rotation shaft 150 of the top rotation plate 120 thereto. The motor bottom support body 400 has electric wires 430 and 440 for supplying power to an electronic circuit and the electromagnets 20.

FIGS. 6 and 7 show the operating principle of the DC motor, and when it is assumed that one electromagnet moves, in a section A indicating an initial state wherein power is not applied yet to the motor, top and bottom permanent magnets attract the electromagnet because of the magnetic metal of the electromagnet. In this case, as shown, the electromagnet is located between the N-pole top permanent magnet and the S-pole bottom permanent magnet. When the motor is initially made, separation distances between the top and bottom permanent magnets and the electromagnets may be different from each other, and otherwise, top and bottom magnetic materials of the electromagnets may be adjusted in size to allow the forces received from the top and bottom permanent magnets to be different from each other. Accordingly, when power is applied to the motor at an initial position of a rotor, the motor is rotatable. If the top and bottom permanent magnets attracting the magnetic materials of the electromagnet have the same force as each other, the force moving to the left and the force moving to the right are equal to each other when power is applied to the electromagnet, no rotation is generated. In the figures, it is assumed that the electromagnet is closer to the top permanent magnet than the bottom permanent magnet. In a section B indicating a state wherein power is initially applied to the motor, the electromagnet moves to the right because a force of top of the electromagnet that moves to the right is stronger than a force of bottom of the electromagnet that moves to the left. In a section C, the electromagnet moves strongly to the right because a force of top of the electromagnet that moves to the right is strongest and an upwardly pushing force of bottom of the electromagnet is strong. In a section D, the electromagnet moves most strongly to the right because forces of top and bottom of the electromagnet that move to the right are strong. In a section E like the section D, the electromagnet moves strongly to the right because forces of top and bottom of the electromagnet that move to the right are strong. In a section F where power application to the electromagnet is blocked, the electromagnet moves through the attraction between the magnetic materials of the electromagnet and the permanent magnets, and because the force of the bottom of the electromagnet that moves to the right is stronger than the force of the top of the electromagnet, the electromagnet moves to the right just through the force of the permanent magnet. In a section G, the electromagnet moves to the right just through the force of the permanent magnet, which is continuously carried out after the section F. In a section H where even though power is applied again to the electromagnet, power with the opposite polarity to the applied polarity in the sections B to F is applied to change the electromagnetic field of the electromagnet, the electromagnet continuously moves to the right by means of its inertia, without having any force, because a force of top of the electromagnet that moves to the right is equal to a force of bottom of the electromagnet that moves to the left. As the rotation section where power is not applied is increased through the adjustment in positions of the hall sensors, the section H may be removable, but because the rotation section where power is applied is accordingly reduced, a rotation speed may be decreased. Accordingly, the positions of the hall sensors are adjusted in consideration of the efficiencies and rotation forces of the motor according to the use purposes of the motor. In a section I like the section B, the electromagnet moves to the right because a force of top of the electromagnet that moves to the right is stronger than a force of bottom of the electromagnet that moves to the left. In sections J to L, the electromagnet operates in the same manner as in the sections C to F.

### INDUSTRIAL APPLICABILITY

According to the present invention, the high-efficiency DC motor may replace the DC motors used in overall industrial fields therewith and greatly improve the performance when compared to the existing DC motors, thereby exhibiting high-speed rotation, high energy efficiency, low operating cost, and improvements in the performance of a product using the motor. In specific, if the high-efficiency DC motor according to the present invention is applied to wireless electrical equipment such as electric cars, flying cars, drones, and the like, the DC motor provides good energy efficiency so that the equipment can operate for a longer period of time than that in the existing motor, without charging a battery. Further, the high-efficiency DC motor according to the present invention is simple in configuration, modularized, and automatically produced, thereby greatly reducing a manufacturing cost.

1. (canceled)

2. A rotating electric device comprising:
upper permanent magnets arranged in a circular shape around the upper of a rotation shaft in a vertical direction of the rotation shaft for neighboring upper permanent magnets to have different polarities from each other;
lower permanent magnets arranged in a circular shape around the lower of the rotation shaft in the vertical direction of the rotation shaft for neighboring lower permanent magnets to have different polarities from each other, wherein the center of the lower permanent magnets is placed between the upper permanent magnets;
a plurality of electromagnets arranged in a shape of a cylinder between the upper permanent magnets and the lower permanent magnets for neighboring electromagnets to have different polarities from each other when electricity is applied to the plurality of electromagnets; and
a fixture for fixing the plurality of electromagnets between the upper permanent magnets and the lower permanent magnets and the plurality of electromagnets,
wherein the plurality of electromagnets are located closer to any one of the lower permanent magnets and the upper permanent magnets than the other.

3. A rotating electric device comprising:
upper permanent magnets arranged in a circular shape around the upper of a rotation shaft in a vertical direction of the rotation shaft for neighboring upper permanent magnets to have different polarities from each other;
lower permanent magnets arranged in a circular shape around the lower of the rotation shaft in the vertical direction of the rotation shaft for neighboring lower permanent magnets to have different polarities from each other, wherein the center of the lower permanent magnets is placed between the upper permanent magnets;
a plurality of electromagnets arranged in a shape of a cylinder between the upper permanent magnets and the lower permanent magnets for neighboring electromagnets to have different polarities from each other when electricity is applied to the plurality of electromagnets; and
a fixture for fixing the plurality of electromagnets between the upper permanent magnets and the lower permanent magnets and the plurality of electromagnets,
wherein the sizes of lower permanent magnets are difference from the sized of the upper permanent magnets.

4. A rotating control method for rotating a rotating electric device,
wherein the rotating electric device comprising:
upper permanent magnets arranged in a circular shape around the upper of a rotation shaft in a vertical direction of the rotation shaft for neighboring upper permanent magnets to have different polarities from each other;
lower permanent magnets arranged in a circular shape around the lower of the rotation shaft in the vertical direction of the rotation shaft for neighboring lower permanent magnets to have different polarities from each other, wherein the center of the lower permanent magnets is placed between the upper permanent magnets;
a plurality of electromagnets arranged in a shape of a cylinder between the upper permanent magnets and the lower permanent magnets for neighboring electromagnets to have different polarities from each other when electricity is applied to the plurality of electromagnets; and
a fixture for fixing the plurality of electromagnets between the upper permanent magnets and the lower permanent magnets and the plurality of electromagnets,
the rotating control method comprising:
a first step of ceasing supplying forward power to a k-th electromagnet to cease supplying forward rotational force to the k-th electromagnet when the center line of the k-th electromagnet rotating in the forward direction coincides with the center line of an n-th upper permanent magnet and is located between an m-th lower permanent magnet and an (m+1)-th lower permanent magnet, the k, m, and n being integers;
a second step of supplying backward power to the k-th electromagnet to continuously rotate the k-th electromagnet in the forward direction when the center line of the k-th electromagnet rotating in the forward direction deviates from the center line of the n-th upper permanent magnet and a space between the m-th lower permanent magnet and the (m+1)-th lower permanent magnet;
a third step of ceasing supplying backward power to the k-th electromagnet to cease supplying forward rotational force to the k-th electromagnet when the center line of the k-th electromagnet coincides with the center line of an (n+1)-th upper permanent magnet and is located between the (m+1)-th lower permanent magnet and an (m+2)-th lower permanent magnet;
a fourth step of supplying forward power to the k-th electromagnet to continuously rotate the k-th electromagnet in the forward direction when the center line of the k-th electromagnet rotating in the forward direction deviates from the center line of the (n+1)-th upper permanent magnet and a space between the (m+1)-th lower permanent magnet and the (m+2)-th lower permanent magnet; and
repeating the first, second, third, and fourth steps.
